(19) United States
(12) Patent Application Publication
(10) Pub. No.: US 2026/0229395 A1
(43) Pub. Date: Aug. 6, 2026

(54) HIGH-VOLTAGE GENERATOR

(71) Applicant: Delta Electronics (Shanghai) Co., Ltd., Shanghai (CN)

(72) Inventors: Yingqi ZHANG, Shanghai (CN); Yongtao WANG, Shanghai (CN); Yuhao LI, Shanghai (CN); CHICHIEH CHENG, Shanghai (CN); Haijun YANG, Shanghai (CN); Shaohua ZHU, Shanghai (CN)

(21) Appl. No.: 19/531,623

(22) Filed: Feb. 5, 2026

(30) Foreign Application Priority Data
Feb. 6, 2025 (CN) 202510134724.3

(51) Int. Cl. H01F 27/24; H01F 27/30; H01J 35/02; H02M 3/335

(52) U.S. Cl. CPC H01F 27/24; H01F 27/306; H01J 35/025; H02M 3/33569

(57) ABSTRACT

The present application provides a high voltage generator including a first inverter module, a first resonant module, a first transformer module and a first rectifier module which are electrically connected in sequence; and a second inverter module, a second resonant module, a second transformer module and a second rectifier module which are electrically connected in sequence. The first transformer module includes a first primary winding and a first secondary winding, and the second transformer module includes a second primary winding and a second secondary winding. Input terminals of the first inverter module and the second inverter module are connected in parallel, and output terminals of the first rectifier module and the second rectifier module are connected in series to form a high voltage. The output voltage of the first inverter module and the output voltage of the second inverter module have different phases.

### CROSS-REFERENCE TO RELATED APPLICATION

This application claims priority to Chinese Patent Application No. 202510134724.3, filed on February 06, 2025, which is hereby incorporated by reference in its entirety.

### TECHNICAL FIELD

The present application relates to electrical technology, especially relates to a high-voltage generator.

### BACKGROUND

The X-ray high voltage generator is a device used to produce X-rays and is widely used in medical imaging. The X-ray high voltage generator converts the input electrical energy into a high voltage, which accelerates electrons to strike the target material, generating X-rays.

In order to ensure the image quality of X-rays, the high-voltage generator needs to meet the requirement of low voltage ripple. At present, this is achieved by increasing the capacitance of the high-voltage filter capacitor, which results in a small voltage ripple in the high voltage output by the high-voltage generator.

However, a larger capacitance value brings several disadvantages: it requires a longer time to charge a larger capacitance to a higher voltage, as well as a longer time to discharge it to a lower voltage. This prolongs the rise time of establishing a high voltage and the fall time of high voltage. When dynamic voltage switching is required for the high voltage, the larger capacitance value limits the ability of rapid voltage change, extending a response time of voltage adjustment, which results in longer rising and falling times. However, the long rising time and falling time will slow down the response of the high-voltage generator, affect imaging quality and bring additional radiation dose to the patient.

### SUMMARY

In one aspect, the present application provides a high-voltage generator. The high-voltage generator includes:

a first inverter module, a first resonant module, a first transformer module and a first rectifier module which are electrically connected in sequence; and a second inverter module, a second resonant module, a second transformer module and a second rectifier module which are electrically connected in sequence;

the first transformer module includes a first primary winding and a first secondary winding;

the second transformer module includes a second primary winding and a second secondary winding;

where input terminals of the first inverter module and the second inverter module are connected in parallel;

output terminals of the first rectifier module and the second rectifier module are connected in series to form a high voltage;

a phase of an output voltage of the first inverter module and a phase of an output voltage of the second inverter module are different.

In another aspect, the present application provides a high-voltage generator. The high-voltage generator includes:

a three-phase inverter module, a resonant module, a transformer module and a rectifier module which are electrically connected in sequence;

the three-phase inverter module includes three bridge arms and a capacitor connected in parallel;

the transformation module includes three primary windings and three secondary windings, where the three primary windings are provided with a common connection point, and the three primary windings are respectively coupled with the three secondary windings;

each of midpoints of the three bridge arms is connected with the common connection point through a series connection of a resonant inductor, a resonant capacitor and one of the three primary windings;

the rectifier module includes three rectifier units electrically connected with the three secondary windings respectively, and output terminals of the three rectifier units are connected in series; and

each phase of the three-phase inverter module has a different output voltage.

### BRIEF DESCRIPTION OF DRAWINGS

The accompanying drawings are incorporated into the description and constitute part of the present specification, showing embodiments that are consistent with the present application and are used together with the present description to explain the principles of the present application.

FIG. 1 is a circuit schematic diagram of a high-voltage generator provided by an embodiment of the present application.

FIG. 2 is an inductor schematic diagram provided by an embodiment of the present application.

FIG. 3 is another inductor schematic diagram provided by an embodiment of the present application.

FIG. 4 is yet another inductor schematic diagram provided by an embodiment of the present application.

FIG. 5 is another circuit schematic diagram of a high-voltage generator provided by an embodiment of the present application.

FIG. 6 is a winding schematic diagram provided by an embodiment of the present application.

FIG. 7 is a working waveform diagram of a high-voltage generator provided by an embodiment of the present application.

FIG. 8 is another working waveform diagram of a high-voltage generator provided by an embodiment of the present application.

FIG. 9 is yet another circuit schematic diagram of a high-voltage generator provided by an embodiment of the present application.

Through the above drawings, clear embodiments of the present application have been shown, and will be described in more detail later. These drawings and written descriptions are not intended to limit the scope of the concept of the present application in any way, but to explain the concept of the present application to those skilled in the art by referring to specific embodiments.

### DESCRIPTION OF EMBODIMENTS

The exemplary embodiments will be described in detail here, with examples shown in the accompanying drawings. When the following description refers to the drawings, unless otherwise indicated, the same numbers in different drawings indicate the same or similar elements. The embodiments described in the following exemplary embodiments do not represent all embodiments consistent with the present application. Instead, they are merely examples of devices and methods consistent with certain aspects of the present application as detailed in the appended claims.

The rectifier output side of the high-voltage generator has a large ripple current. At present, the voltage ripple is mainly reduced by a high-voltage filter capacitor with larger capacitance. However, the filter capacitor with larger capacitance makes the establishment and dynamical change of the high voltage in the high-voltage generator take a long time, which leads to the slow response of the high-voltage generator, affects imaging quality and brings extra radiation dose to patients.

In view of the above, the present application provides a high-voltage generator. By using a first inverter module and a second inverter module to output voltages with different phases, a phase-shift occurs in the voltages of the secondary windings in the two transformer modules, thereby causing the ripple voltages of the secondary windings in the two transformer modules to partially cancel each other out, reducing the voltage ripple of the high voltage output by the high-voltage generator, improving the response speed of the high-voltage generator, enhancing the imaging quality, and reducing the radiation dose to the patient.

The technical scheme of the present application and how the technical scheme of the present application can solve the above technical problems will be described in detail with specific examples. The following specific embodiments can be combined with each other, and the same or similar concepts or processes may not be repeated in some embodiments. Embodiments of the present application will be described below with reference to the accompanying drawings.

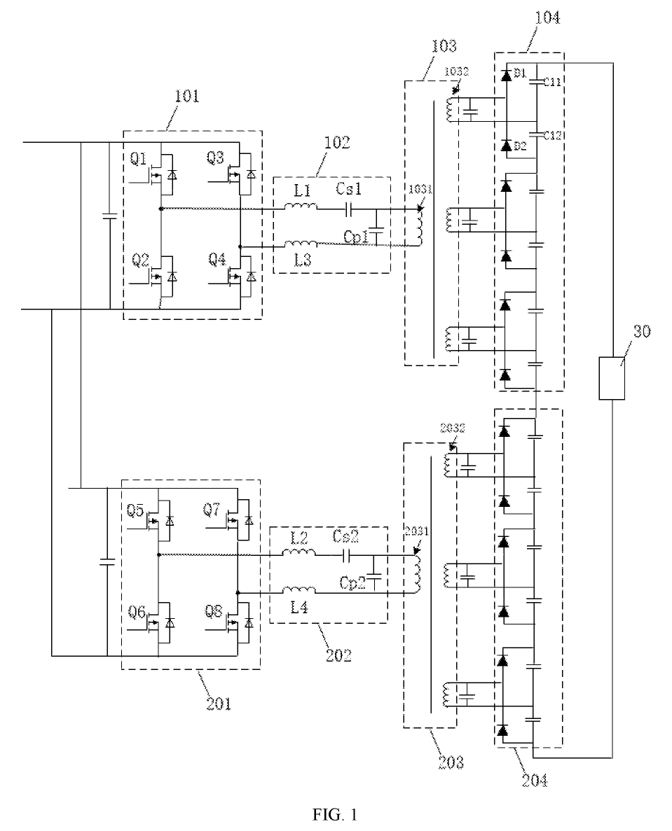

FIG. 1 is a high-voltage generator provided by an embodiment of the present application. As shown in FIG. 1, the high-voltage generator provided by an embodiment of the present application may include:

a first inverter module 101, a first resonant module 102, a first transformer module 103 and a first rectifier module 104 which are electrically connected in sequence; a second inverter module 201, a second resonant module 202, a second transformer module 203 and a second rectifier module 204 which are electrically connected in sequence; the first transformer module 103 includes a first primary winding 1031 and a first secondary winding 1032, and the second transformer module 203 includes a second primary winding 2031 and a second secondary winding 2032.

An input terminal of the first inverter module 101 and an input terminal of the second inverter module 201 are connected in parallel, and an output terminal of the first rectifier module 104 and an output terminal of the second rectifier module 204 are connected in series to form a high voltage. An output voltage of the first inverter module 101 and an output voltage of the second inverter module 201 have different phases, this phase difference causes the voltages of the first secondary winding 1032 and the second secondary winding 2032 to be phase-shifted, allowing part of the ripple voltages of the first secondary winding 1032 and the second secondary winding 2032 to cancel each other out, thereby reducing the voltage ripple of the output high voltage.

An input terminal of the first resonant module 102 is connected with an output terminal of the first inverter module 101, and an input terminal of the second resonant module 202 is connected with an output terminal of the second inverter module 201. The first resonant module 102 can perform frequency processing on the alternating current output by the first inverter module 101, and the second resonant module 202 can perform frequency processing on the alternating current output by the second inverter module 201. Frequency processing is used to optimize frequency characteristics and improve energy transfer efficiency.

An input terminal of the first transformer module 103 is connected to an output terminal of the first resonant module 102, and an input terminal of the second transformer module 203 is connected to an output terminal of the second resonant module 202. The first transformer module 103 may be configured to boost the alternating current output by the first resonant module 102, and the second transformer module 203 can boost the alternating current output by the second resonant module 202.

The input terminal of the first rectifier module 104 is connected to the output terminal of the first transformer module 103, and the input terminal of the second rectifier module 204 is connected to the output terminal of the second transformer module 203. The first rectifier module 104 is configured to convert the alternating current output by the first transformer module 103 into direct current, and the second rectifier module 204 is configured to convert the alternating current output by the second transformer module 203 into direct current.

Based on the above inverter modules, resonant modules, transformer modules and rectifier modules, the high-voltage generator can output a high voltage, and the specific value of the high voltage is related to the actual scenario where the high-voltage generator is applicable. The high-voltage generator can output different high voltages for different scenario.

Additionally, the first transformer module 103 includes a first primary winding 1031 and a first secondary winding 1032, and the second transformer module 203 includes a second primary winding 2031 and a second secondary winding 2032. Since the output voltage of the first inverter module 101 and the output voltage of the second inverter module 201 are different in phase, the voltage of the first primary winding 1031 and the voltage of the second primary winding 2031 are different in phase. Accordingly, the voltage of the first secondary winding 1032 and the voltage of the second secondary winding 2032 may cancel out part of the voltage ripple when superposed in series by the first rectifier module 104 and the second rectifier module 204, thereby reducing the voltage ripple of the high voltage output by the high-voltage generator, and thus avoiding the need to increase the capacitance value of the high-voltage filter capacitor, improving the response speed of the high-voltage generator, improving the imaging quality and reducing the radiation dose to patients.

For example, a first input terminal of the first inverter module 101 is connected to a first input terminal of the second inverter module 201, and a second input terminal of the first inverter module 101 is connected to a second input terminal of the second inverter module 201.

A first input terminal of the first resonant module 102 is connected to a first output terminal of the first inverter module 101, and a second input terminal of the first resonant module 102 is connected to a second output terminal of the first inverter module 101. A first terminal of the first primary winding 1031 is connected to a first output terminal of the first resonant module 102, and a second terminal of a first primary winding 1031 is connected to a second output terminal of the first resonant module 102. A first terminal of the first secondary winding 1032 is connected to a first input terminal of the first rectifier module 104, and a second terminal of the first secondary winding 1032 is connected to a second input terminal of the first rectifier module 104.

A first input terminal of the second resonant module 202 is connected to a first output terminal of the second inverter module 201, and a second input terminal of the second resonant module 202 is connected to a second output terminal of the second inverter module 201. A first terminal of the second primary winding 2031 is connected to a first output terminal of the second resonant module 202, and a second terminal of the second primary winding 2031 is connected to a second output terminal of the second resonant module 202. A first terminal of the second secondary winding 2032 is connected to a first input terminal of the second rectifier module 204, and a second terminal of the second secondary winding 2032 is connected to a second input terminal of the second rectifier module 204.

A first output terminal of the first rectifier module 104 is connected to a first terminal of the load 30, and a second output terminal of the first rectifier module 104 is connected to a first output terminal of the second rectifier module 204. The second output terminal of the second rectifier module 204 is connected to a second terminal of the load 30.

For example, the load 30 may be an X-ray tube. The output terminal of the high-voltage generator is connected with an anode and a cathode of the X-ray tube, thus establishing a strong electric field between the anode and the cathode. This field accelerates the movement of electrons from the cathode to the anode. When these high-speed electrons strike the anode target, X-rays are generated.

In a specific implementation, a filter capacitor can be connected between the first input terminal and the second input terminal of the first inverter module 101 for filtering the direct current received by the first inverter module 101. The filter capacitor may also be connected between the first input terminal and the second input terminal of the second inverter module 201 for filtering the direct current received by the second inverter module 201.

In some examples, as shown in FIG. 1, the first inverter module 101 includes a first bridge arm and a second bridge arm. A first terminal of the first bridge arm is connected with a first terminal of the second bridge arm, and serves as the first input terminal of the first inverter module 101. A second terminal of the first bridge arm is connected with a second terminal of the second bridge arm, and serves as the second input terminal of the first inverter module 101. A third terminal of the first bridge arm serves as the first output terminal of the first inverter module 101, and a third terminal of the second bridge arm serves as the second output terminal of the first inverter module 101.

For example, the first bridge arm includes a first switching transistor Q1 and a second switching transistor Q2. A first terminal of the first switching transistor Q1 serves as the first terminal of the first bridge arm. A second terminal of the first switching transistor Q1 is connected with a first terminal of the second switching transistor Q2, and serves as the third terminal of the first bridge arm. A second terminal of the second switching transistor Q2 serves as the second terminal of the first bridge arm.

For example, the second bridge arm includes a third switching transistor Q3 and a fourth switching transistor Q4. A first terminal of the third switching transistor Q3 serves as the first terminal of the second bridge arm. A second terminal of the third switching transistor Q3 is connected with a first terminal of the fourth switching transistor Q4, and serves as the third terminal of the second bridge arm. A second terminal of the fourth switching transistor Q4 serves as the second terminal of the second bridge arm.

In some examples, the second inverter module 201 includes a third bridge arm and a fourth bridge arm. A first terminal of the third bridge arm is connected with a first terminal of the fourth bridge arm, and serves as the first input terminal of the second inverter module 201. A second terminal of the third bridge arm is connected with a second terminal of the fourth bridge arm, and serves as the second input terminal of the second inverter module 201. A third terminal of the third bridge arm serves as the first output terminal of the second inverter module 201, and a third terminal of the fourth bridge arm serves as the second output terminal of the second inverter module 201.

For example, the third bridge arm includes a fifth switching transistor Q5 and a sixth switching transistor Q6. A first terminal of the fifth switching transistor Q5 serves as a first terminal of the third bridge arm. A second terminal of the fifth switching transistor Q5 is connected with a first terminal of the sixth switching transistor Q6, and serves as the third terminal of the third bridge arm. A second terminal of the sixth switching transistor Q6 serves as the second terminal of the third bridge arm.

For example, the fourth bridge arm may include a seventh switching transistor Q7 and an eighth switching transistor Q8. A first terminal of the seventh switching transistor Q7 serves as the first terminal of the fourth bridge arm. A second terminal of the seventh switching transistor Q7 is connected with a first terminal of the eighth switching transistor Q8, and serves as the third terminal of the fourth bridge arm. A second terminal of the eighth switching transistor Q8 serves as the second terminal of the fourth bridge arm.

For example, the first switching transistor Q1 to the eighth switching transistor Q8 may be MOSFET transistors, drains of which are the first terminals of the switching transistors, and sources of which are the second terminals of the switching transistors.

Accordingly, control terminals of the first switching transistor Q1 to the eighth switching transistor Q8 may receive corresponding control signals, and each switching transistor is turned on or off under the action of the corresponding control signals, thus resulting in different phases of output voltages of the first inverter module 101 and the second inverter module 201.

For example, the output voltage of the first inverter module 101 has a phase of 0°, while the output voltage of the second inverter module 201 has a phase of 90°. This phase difference helps to more effectively cancel out part of the ripple voltage.

In some examples, as shown in FIG. 1, the first resonant module 102 includes a first inductor L1 and a first resonant capacitor Cs1 connected in series, and the second resonant module 202 includes a second inductor L2 and a second resonant capacitor Cs2 connected in series. The inductance difference between the first inductor L1 and the second inductor L2 is within a preset range. This helps to reduce the inductance difference between the first inductor L1 and the second inductor L2, balance the power of the first resonant module 102 and the second resonant module 202, and enhance the stability of the high-voltage generator. The preset range can be determined according to the specific characteristics of the two inductors.

As a specific implementation, as shown in FIG. 1, the first resonant module 102 includes a first inductor L1, a first resonant capacitor Cs1 and a third resonant capacitor Cp1 connected in series. A first terminal of the first inductor L1 serves as the first input terminal of the first resonant module 102. A second terminal of the first inductor L1 is connected to a first terminal of the first resonant capacitor Cs1. A second terminal of the first resonant capacitor Cs1 is connected to a first terminal of the third resonant capacitor Cp1, and serves as the first output terminal of the first resonant module 102. A second terminal of the third resonant capacitor Cp1 serves as the second input terminal and the second output terminal of the first resonant module 102.

The second resonant module 202 includes a second inductor L2, a second resonant capacitor Cs2 and a fourth resonant capacitor Cp2 connected in series. A first terminal of the second inductor L2 serves as the first input terminal of the second resonant module 202. A second terminal of the second inductor L2 is connected to a first terminal of the second resonant capacitor Cs2. A second terminal of the second resonant capacitor Cs2 is connected to a first terminal of the fourth resonant capacitor Cp2, and serves as the first output terminal of the second resonant module 202. A second terminal of the fourth resonant capacitor Cp2 serves as the second input terminal and the second output terminal of the second resonant module 202.

Accordingly, the first primary winding 1031 may be connected in parallel with the third resonant capacitor Cp1, and the second primary winding 2031 may be connected in parallel with the fourth resonant capacitor Cp2. Through the LCC resonant circuit, more efficient energy transfer, better output quality and lower switching loss can be realized, and the performance and reliability of the entire high-voltage generator can be improved.

In some examples, as shown in FIG. 1, the first resonant module 102 may further include a third inductor L3. A first terminal of the third inductor L3 serves as the second input terminal of the first resonant module 102. A second terminal of the third inductor L3 is connected with the second terminal of the third resonant capacitor Cp1, and serves as the second output terminal of the first resonant module 102. The second resonant module 202 may further include a fourth inductor L4. A first terminal of the fourth inductor L4 serves as the second input terminal of the second resonant module 202. A second terminal of the fourth inductor L4 is connected with the second terminal of the fourth resonant capacitor Cp2, and serves as the second output terminal of the second resonant module 202. The third inductor L3 and the fourth inductor L4 can enhance the flexibility of the resonant module and enable more complex frequency response.

For example, the third inductor L3 and the first inductor L1 may be arranged oppositely, and the fourth inductor L4 and the second inductor L2 may be arranged oppositely, so that mutual inductance can be generated and the energy transfer effect can be improved.

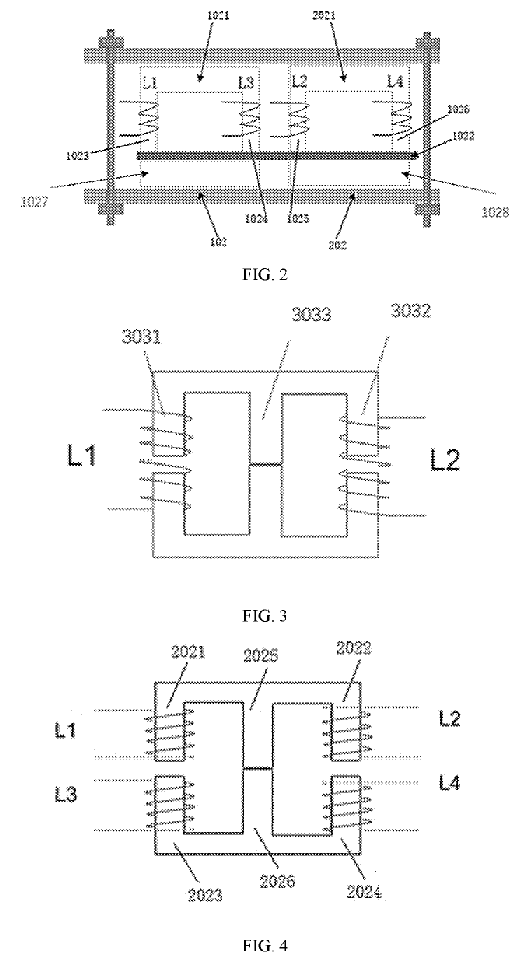

In a specific implementation, as shown in FIG. 2, the first inductor L1 includes a first UI-type magnetic core and the second inductor L2 includes a second UI-type magnetic core. The first UI-type magnetic core and the second UI-type magnetic core use the same insulating component, so the first inductor L1 and the second inductor L2 have the same air gap. This reduces the inductance difference between the two inductors and helps to balance the power of the first resonant module 102 and the second resonant module 202.

It should be noted that in the UI-type magnetic core, the U-type magnetic core provides the main structural support, and is usually used for winding coils. The coils can be directly wound on two magnetic pillars of the U-type magnetic core. The I-type magnetic core primarily serves as a closed magnetic circuit, connecting two magnetic pillars of the U-type magnetic core to form a complete magnetic circuit. This configuration helps to reduce magnetic flux leakage and improve the efficiency of the magnetic circuit. By adding an air gap between the U-type magnetic core and the I-type magnetic core, the magnetic characteristics of the magnetic circuit can be adjusted. For example, the inductance can be adjusted and the magnetic core can be prevented from saturation.

For example, as shown in FIG. 2, the first UI-type magnetic core includes a first magnetic pillar 1023 and a second magnetic pillar 1024, and an I-type magnetic core 1027. The second UI-type magnetic core includes a first magnetic pillar 1025 and a second magnetic pillar 1026, and an I-type magnetic core 1028. The first UI-type magnetic core and the second UI-type magnetic core share an insulating component 1022. A coil can be wound on the first magnetic pillar 1023 of the first UI-type magnetic core to form the first inductor L1, and a coil can be wound on the first magnetic pillar 1025 of the second UI-type magnetic core to form the second inductor L2.

For example, the third inductor L3 can be formed by winding a coil on the second magnetic pillar 1024 of the first UI-type magnetic core, and the fourth inductor L4 can be formed by winding a coil on the second magnetic pillar 1026 of the second UI-type magnetic core, so that the third inductor L3 and the first inductor L1 share the first UI-type magnetic core, and the fourth inductor L4 and the second inductor L2 share the second UI-type magnetic core.

In practical application, two inductors can be integrated using mechanical connectors such as bolts or clamps, with an insulating strip used to create the air gap. This helps to reduce the inductance difference between the two inductors.

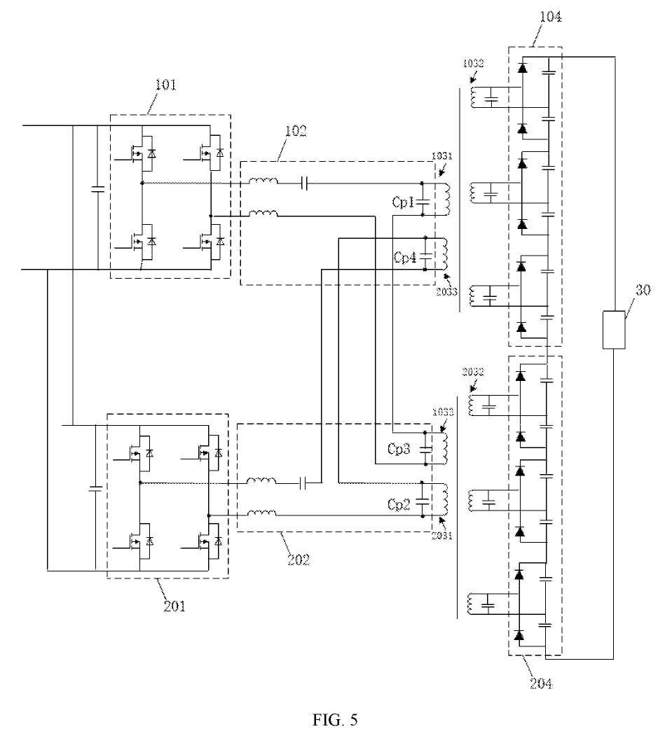

In another specific implementation, as shown in FIG. 3, the first inductor L1 and the second inductor L2 share a third EE-type magnetic core. The third EE-type magnetic core includes two oppositely arranged E-type magnetic cores. The winding of the first inductor L1 is wound around the first magnetic pillar 3031 of the third EE-type magnetic core, and the winding of the second inductor L2 is wound around the second magnetic pillar 3032 of the third EE-type magnetic core. The first inductor L1 and the second inductor L2 use the same magnetic core to reduce the inductance difference between the two inductors. This helps to balance the power of the first resonant module 102 and the second resonant module 202.

For example, the first magnetic pillar 3031 and the second magnetic pillar 3032 of the third EE-type magnetic core each have a third air gap. The central pillar 3033 of the third EE-type magnetic core has a fourth air gap, and the width of the fourth air gap is smaller than that of the third air gap. Due to the phase difference between the current of the first resonant module 101 and the current of the second resonant module 201, to avoid magnetic coupling, the magnetic reluctance of the central pillar should be smaller than the magnetic reluctance of the magnetic pillar. By making the magnetic reluctance of the central pillar smaller than the magnetic reluctance of the magnetic pillar, most of the flux linkage generated by the magnetic pillar is decoupled through the central pillar, thus reducing the mutual influence between the first resonant module 101 and the second resonant module 201.

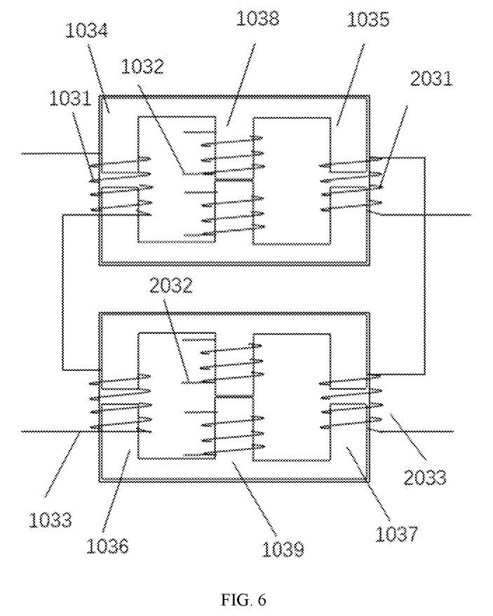

In another specific implementation, as shown in FIG. 4, the first inductor L1 and the second inductor L2 share the first E-type magnetic core. The first inductor L1 and the second inductor L2 use the same magnetic core, which helps to reduce the inductance difference between the two inductors and balance the power of the first resonant module 102 and the second resonant module 202.

For example, the first resonant module 102 further includes a third inductor L3, and the second resonant module 202 further includes a fourth inductor L4. The third inductor L3 is connected in series with the first inductor L1, and the fourth inductor L4 is connected in series with the second inductor L2. The third inductor L3 and the fourth inductor L4 may also share the second E-type magnetic core. The third inductor L3 and the fourth inductor L4 use the same magnetic core. The first E-type magnetic core and the second E-type magnetic core are arranged oppositely.

Therefore, the first inductor L1, the second inductor L2, the third inductor L3 and the fourth inductor L4 may all be integrated in a fourth EE-type magnetic core. The fourth EE-type magnetic core includes a first E-type magnetic core and a second E-type magnetic core which are oppositely arranged. The first E-type magnetic core includes a first magnetic pillar 2021 and a second magnetic pillar 2022. The second E-type magnetic core includes a first magnetic pillar 2023 and a second magnetic pillar 2024. The first magnetic pillar 2021 of the first E-type magnetic core and the first magnetic pillar 2023 of the second E-type magnetic core are oppositely arranged, and the second magnetic pillar 2022 of the first E-type magnetic core and the second magnetic pillar 2024 of the second E-type magnetic core are oppositely arranged. The first inductor L1 may be formed by winding a coil on the first magnetic pillar 2021 of the first E-type magnetic core, and the second inductor L2 can be formed by winding a coil on the second magnetic pillar 2022 of the first E-type magnetic core. The third inductor L3 may be formed by winding a coil on the first magnetic pillar 2023 of the second E-type magnetic core, and a fourth inductor L4 by winding a coil on the second magnetic pillar 2024 of the second E-type magnetic core.

Accordingly, the first inductor L1 and the second inductor L2 may use the same magnetic core, the third inductor L3 and the fourth inductor L4 can use the same magnetic core. An air gap between the first inductor L1 and the third inductor L3, and an air gap between the second inductor L2 and the fourth inductor L4 may be created with the same insulating strip, so as to adjust the magnetic characteristics of the magnetic circuit.

As a specific implementation, the first magnetic pillar 2021 of the first E-type magnetic core and the first magnetic pillar 2023 of the second E-type magnetic core each have a third air gap, the second magnetic pillar 2022 of the first E-type magnetic core and the second magnetic pillar 2024 of the second E-type magnetic core each have a third air gap, and the central pillar 2025 of the first E-type magnetic core and the central pillar 2026 of the second E-type magnetic core each have a fourth air gap. The width of the third air gap is greater than that of the fourth air gap. Due to the phase difference between the current of the first resonant module 101 and the current of the second resonant module 201, to avoid magnetic coupling, the magnetic reluctance of the central pillar should be smaller than the magnetic reluctance of the magnetic pillar. By making the magnetic reluctance of the central pillar smaller than the magnetic reluctance of the magnetic pillar, most of the flux linkage generated by the magnetic pillar is decoupled through the central pillar, reducing the mutual influence between the first resonant module 101 and the second resonant module 201.

In some embodiments, as shown in FIG. 5, the first transformer module 103 further includes a third primary winding 1033, and the second transformer module 203 includes a fourth primary winding 2033. The third primary winding 1033 is connected in series with the first primary winding 1031 and coupled with the second secondary winding 2032. The first inverter module 101 and the second inverter module 201 are respectively cross-connected in series with one winding of the two transformer modules, so as to realize the power balance of the two transformer modules and the phase-shift of the voltage of the two secondary windings. Since the two secondary windings are connected with the two rectifier modules which are connected in series, the voltages of the two rectifier modules are phase-shifted, allowing for partial voltage ripple cancellation after being connected in series.

In some examples, as shown in FIG. 6, the first transformer module 103 includes two oppositely arranged E-type magnetic cores to form a first EE-type magnetic core, and the second transformer module 203 includes two oppositely arranged E-type magnetic cores to form a second EE-type magnetic core. The first primary winding 1031 is wound around the first magnetic pillar 1034 of the first EE-type magnetic core. The third primary winding 1033 is wound around the first magnetic pillar 1036 of the second EE-type magnetic core. The second primary winding 2031 is wound around the second magnetic pillar 1035 of the first EE-type magnetic core, and the fourth primary winding 2033 is wound around the second magnetic pillar 1037 of the second EE-type magnetic core. The first secondary winding 1032 is wound around the first central pillar 1038 of the first EE-type magnetic core, and the second secondary winding 2032 is wound around the second central pillar 1039 of the second EE-type magnetic core. The first primary winding 1031 is connected with the third primary winding 1033, and the second primary winding 2031 is connected with the fourth primary winding 2033. The two primary windings of the first transformer module 103 are wound on the first magnetic pillar 1034 of the first EE-type magnetic core and the first magnetic pillar 1036 of the second EE-type magnetic core. The two primary windings of the second transformer module 203 are wound on the second magnetic pillar 1035 and the first EE-type magnetic core and the second magnetic pillar 1037 of the second EE-type magnetic core, so that the flux and heat are better distributed, thereby improving the power density of the transformer modules.

In some examples, the first magnetic pillar 1034 and second magnetic pillar 1035 of the first EE-type magnetic core, the first magnetic pillar 1036 and second magnetic pillar 1037 of the second EE-type magnetic core each have the first air gap. The first central pillar 1038 and the second central pillar 1039 each have a second air gap, the width of the second air gap is smaller than that of the first air gap. Due to the phase difference between the current of the first primary winding 1031 and the current of the second primary winding 2031, and the phase difference between the current of the third primary winding 1033 and the current of the fourth primary winding 2033, in order to avoid magnetic coupling, the magnetic reluctance of the central pillar should be smaller than the magnetic reluctance of the magnetic pillar. The first central pillar 1038 and the second central pillar 1039 each have a second air gap, and the first magnetic pillar and the second magnetic pillar each have a first air gap, so that the magnetic reluctance of the central pillar is smaller than the magnetic reluctance of the magnetic pillar, allowing most of the flux linkage generated by the magnetic pillar to be decoupled through the central pillar, thereby reducing the mutual influence between the first transformer module 103 and the second transformer module 203.

For example, the magnetic reluctance of the first central pillar 1038 of the first EE-type magnetic core is smaller than the magnetic reluctance of the first central pillar 1034 of the first EE-type magnetic core. The magnetic reluctance of the first central pillar 1038 of the first EE-type magnetic core is smaller than the magnetic reluctance of the second central pillar 1035 of the first EE-type magnetic core. The magnetic reluctance of the second central pillar 1039 of the second EE-type magnetic core is smaller than the magnetic reluctance of the first magnetic pillar 1036 of the second EE-type magnetic core. The magnetic reluctance of the second central pillar 1039 of the second EE-type magnetic core is smaller than the magnetic reluctance of the second magnetic pillar 1037 of the second EE-type magnetic core.

In some examples, the first transformer module 103 may include a plurality of first secondary windings 1032, and the number of the first secondary windings 1032 positively correlates with the high voltage output by the high-voltage generator. The second transformer module 203 may include a plurality of second secondary windings 2032, and the number of the second secondary windings 2032 positively correlates with the high voltage output by the high-voltage generator. Therefore, the high voltage output by the high-voltage generator can be controlled by adjusting the number of the first secondary windings 1032 and the number of the second secondary windings 2032.

In some embodiments, as shown in FIG. 1, each of the first rectifier module 104 and the second rectifier module 204 may include a plurality of sub-rectifier modules connected in series. In two adjacent sub-rectifier modules, the second output terminal of the preceding sub-rectifier module is connected with the first output terminal of the following sub-rectifier module. The first output terminal of the first sub-rectifier module and the second output terminal of the last sub-rectifier module are connected to the load 30.

Each sub-rectifier module may include a first diode D1 and a second diode D2 connected in series, and a first filter capacitor C11 and a second filter capacitor C12 connected in series. The anode of the first diode D1 is connected with the cathode of the second diode D2, and serves as the first input terminal of the sub-rectifier module. The second terminal of the first filter capacitor C11 is connected with the first terminal of the second filter capacitor C12, and serves as the second input terminal of the sub-rectifier module. The cathode of the first diode D1 is connected to the first terminal of the first filter capacitor C11, and serves as the first output terminal of the sub-rectifier module. The anode of the second diode D2 is connected to the second terminal of the second filter capacitor C12, and serves as the second output terminal of the sub-rectifier module.

For example, in the positive half cycle of alternating current, the current passes through the first diode D1 to charge the first filter capacitor C11. In the negative half cycle of alternating current, the current passes through the second diode D2 to charge the second filter capacitor C12. Due to the series configuration of the capacitors, the voltages of the two capacitors are superimposed, thus generating a relatively high direct current voltage at the output terminal.

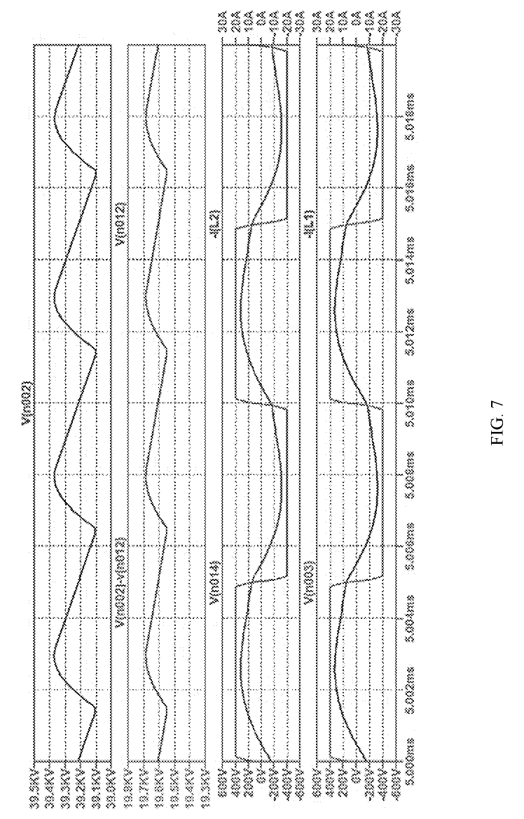

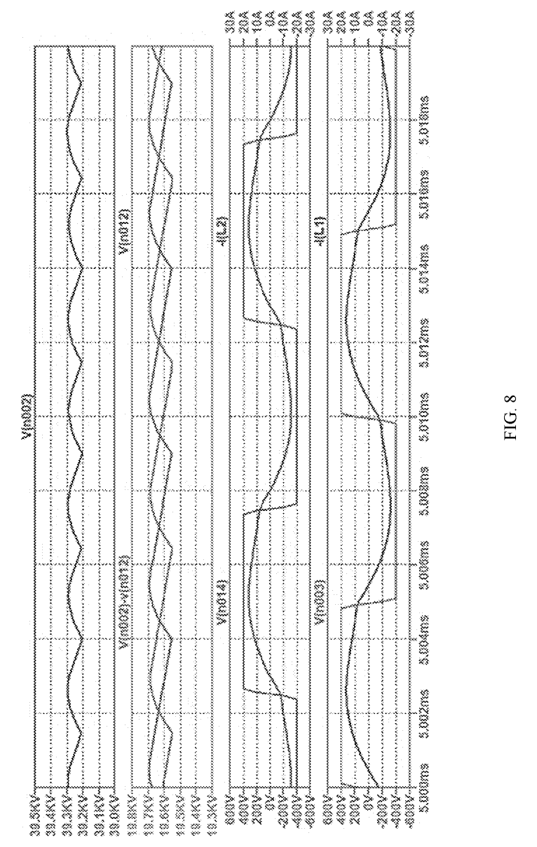

In order to clearly understand the beneficial effects of the scheme in the present application, the working waveform of a high-voltage generator using two identical inverter modules is compared with that of a high-voltage generator using two phase-shifted inverter modules. As shown in FIG. 7 and FIG. 8, FIG. 7 is a schematic diagram of the working waveform of the high-voltage generator in which two identical inverter modules are used to drive the transformer module and the rectifier module. At this time, the ripple pulsation frequency is twice the switching frequency, and the output voltage ripple is relatively large. FIG. 8 is a schematic diagram of the working waveform of the high-voltage generator in which two phase-shifted inverter modules are used to drive the transformer module and the rectifier module. At this time, the ripple frequency of the high-voltage output is four times the switching frequency, and its voltage ripple is relatively small. Therefore, when the transformer module and the rectifier module are driven by two phase-shifted inverter modules, a relatively small filter capacitor may be used in the rectifier module.

The high-voltage generator provided by the embodiments of the present application has been detailed above. By using two-phase inverter modules to output voltages with different phases, a phase-shift occurs in the voltages of the secondary windings in the two transformer modules, causing the ripple voltages of the secondary windings in the two transformer modules to partially cancel each other out, reducing the voltage ripple of the high voltage output by the high-voltage generator, improving the response speed of the high-voltage generator, enhancing the imaging quality, and reducing the radiation dose to patients.

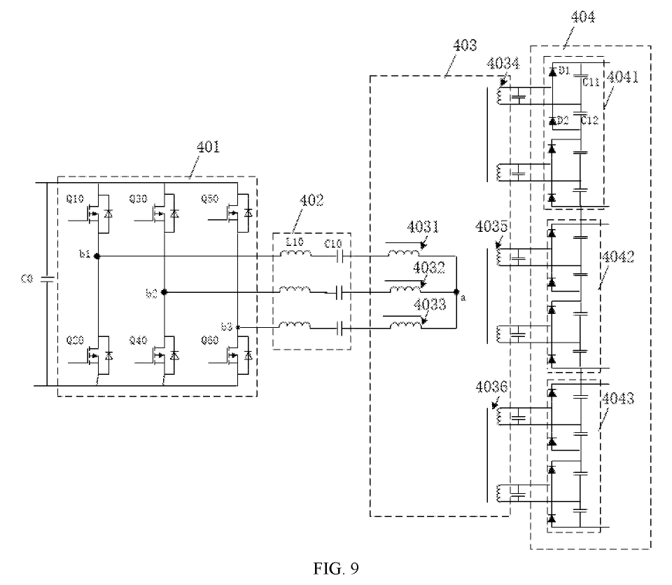

FIG. 9 is another high-voltage generator provided by an embodiment of the present application. As shown in FIG. 9, the high-voltage generator provided by an embodiment of the present application may include a three-phase inverter module 401, a resonant module 402, a transformer module 403 and a rectifier module 404 which are electrically connected in sequence.

The three-phase inverter module 401 includes three bridge arms and a capacitor C0 connected in parallel. The transformer module 403 includes three primary windings and three secondary windings, where the three primary windings have a common connection point a. The three primary windings are respectively coupled with the three secondary windings. Each of the midpoints of the three bridge arms is connected with the common connection point a through a series connection of a resonant inductor, a resonant capacitor and one of the three primary windings. The rectifier module 404 includes three rectifier units electrically connected with the three secondary windings respectively, and the output terminals of the three rectifier units are connected in series to form a high voltage. Each phase of the three-phase inverter module 401 has a different output voltage. This enables the voltages of the three secondary windings to be phase-shifted, allowing part of the ripple voltages in the three secondary windings to cancel each other out. As a result, the voltage ripple of the output high-voltage is reduced.

In the embodiment of the present application, each phase in the three-phase inverter module 401 may an output voltage with a different phase, so the voltage phases of the three primary windings are different. Accordingly, the voltages of the three secondary windings may cancel out part of the voltage ripples when superposed in series by the three rectifier units, thereby reducing the voltage ripple of the high voltage output by the high-voltage generator, and thus avoiding the need to increase the capacitance value of the high-voltage filter capacitor, improving the response speed of the high-voltage generator, improving the imaging quality and reducing the radiation dose to patients.

Among them, the three-phase inverter module 401 may further include a capacitor C0, which is connected between the first input terminal and the second input terminal of the three-phase inverter module 401. The capacitor C0 is used for filtering the direct current received by the three-phase inverter module 401 to provide more stable direct current for the three-phase inverter module 401.

For example, the three-phase inverter module 401 includes a fifth bridge arm, a sixth bridge arm and a seventh bridge arm. The first terminal of the fifth bridge arm, the first terminal of the sixth bridge arm and the first terminal of the seventh bridge arm are connected with each other to form the first input terminal of the three-phase inverter module 401. The second terminal of the fifth bridge arm, the second terminal of the sixth bridge arm and the second terminal of the seventh bridge arm are connected with each other to form the second input terminal of the three-phase inverter module 401.

The fifth bridge arm includes a ninth switching transistor Q10 and a tenth switching transistor Q20. The first terminal of the ninth switching transistor Q10 serves as the first terminal of the fifth bridge arm. The second terminal of the ninth switching transistor Q10 is connected with the first terminal of the tenth switching transistor Q20, and serves as the midpoint b1 of the fifth bridge arm. The second terminal of the tenth switching transistor Q20 serves as the second terminal of the fifth bridge arm.

The sixth bridge arm includes an eleventh switching transistor Q30 and a twelfth switching transistor Q40. The first terminal of the eleventh switching transistor Q30 serves as the first terminal of the sixth bridge arm. The second terminal of the eleventh switching transistor Q30 is connected with the first terminal of the twelfth switching transistor Q40, and serves as the midpoint b2 of the sixth bridge arm. The second terminal of the eleventh switching transistor Q30 serves as the second terminal of the sixth bridge arm.

The seventh bridge arm includes a thirteenth switching transistor Q50 and a fourteenth switching transistor Q60. The first terminal of the thirteenth switching transistor Q50 serves as the first terminal of the seventh bridge arm. The second terminal of the thirteenth switching transistor Q50 is connected with the first terminal of the fourteenth switching transistor Q60, and serves as the midpoint b3 of the seventh bridge arm. The second terminal of the fourteenth switching transistor Q60 serves as the second terminal of the seventh bridge arm.

In a specific real-time implementation, the ninth switching transistor Q10 to the fourteenth switching transistor Q60 may be MOSFET transistors. Drains of the MOSFET transistors are the first terminals of the switching transistors, and sources of the MOSFET transistors are the second terminals of the switching transistors.

Accordingly, the control terminal of each of the ninth switching transistor Q10 to the fourteenth switching transistor Q60 may receive a corresponding control signal. Under the action of the corresponding control signal, each switching transistor is turned on or off, so that each phase in the three-phase inverter module 401 outputs a voltage with a different phase.

For example, the phases of the three-phase output voltages in the three-phase inverter module 401 are 0°, 120°, and 240°, respectively. This configuration achieves a better effect of canceling part of the ripple voltage.

For example, the transformer module 403 includes a fifth primary winding 4031, a sixth primary winding 4032 and a seventh primary winding 4033, and a third secondary winding 4034, a fourth secondary winding 4035 and a fifth secondary winding 4036. The rectifier module 404 includes a first rectifier unit 4041, a second rectifier unit 4042 and a third rectifier unit 4043 connected in series. The fifth primary winding 4031, the sixth primary winding 4032 and the seventh primary winding 4033 have a common connection point a. The fifth primary winding 4031 is coupled with the third secondary winding 4034, the sixth primary winding 4032 is coupled with the fourth secondary winding 4035, and the seventh primary winding 4033 is coupled with the fifth secondary winding 4036. The third secondary winding 4034 is connected to the first rectifier unit 4041, the fourth secondary winding 4035 is connected to the second rectifier unit 4042, and the fifth secondary winding 4036 is connected to the third rectifier unit 4043, so that part of the ripple voltages in the voltage of the third secondary winding 4034, the voltage of the fourth secondary winding 4035 and the voltage of the fifth secondary winding 4036 can be cancelled out after passing through the rectifier module 404.

For example, the resonant module 402 includes a first resonant unit, a second resonant unit and a third resonant unit. The midpoint of the first bridge arm is connected with the first primary winding through the first resonant unit, the midpoint of the second bridge arm is connected with the second primary winding through the second resonant unit, and the midpoint of the third bridge arm is connected with the third primary winding through the third resonant unit. The resonant unit may be used for frequency processing of the alternating current output by the inverter module.

Among them, the first resonant unit, the second resonant unit and the third resonant unit may each include a resonant inductor L10 and a resonant capacitor C10 connected in series.

In some embodiments, each of the three rectifying units may include a plurality of sub-rectifying units connected in series. In two adjacent sub-rectifying units, the second output terminal of the preceding sub-rectifying unit is connected with the first output terminal of the following sub-rectifying unit. The first output terminal of the first sub-rectifying unit and the second output terminal of the last sub-rectifying unit are connected to the load 30.

Each sub-rectifying unit may include a first diode D1 and a second diode D2 connected in series, and a first filter capacitor C11 and a second filter capacitor C12 connected in series. The anode of the first diode D1 is connected with the cathode of the second diode D2 to form the first input terminal of the sub-rectifier module. The second terminal of the first filter capacitor C11 is connected with the first terminal of the second filter capacitor C12 to form the second input terminal of the sub-rectifier module. The cathode of the first diode D1 is connected to the first terminal of the first filter capacitor C11 to form the first output terminal of the sub-rectifier module. The anode of the second diode D2 is connected to the second terminal of the second filter capacitor C12 to form the second output terminal of the sub-rectifier module.

For example, in the positive half cycle of alternating current, the current passes through the first diode D1 to charge the first filter capacitor C11. In the negative half cycle of alternating current, the current passes through the second diode D2 to charge the second filter capacitor C12. Due to the series configuration of the capacitors, the voltages of the two capacitors are superimposed, thus generating a relatively high direct current voltage at the output terminal.

Other embodiments of the present application will easily occur to those skilled in the art after considering the specification and practicing the present application disclosed herein. The present application is intended to cover any variations, uses or adaptations of the present application, which follow the general principles of the present application and include common sense or common technical means in this technical field that are not disclosed in the present application. The specification and examples are to be regarded as exemplary only, with the true scope and spirit of the present application being indicated by the following claims.

It should be understood that the present application is not limited to the precise structure described above and shown in the drawings, and various modifications and changes can be made without departing from its scope. The scope of the present application is limited only by the appended claims.

What is claimed is:

1. A high-voltage generator, comprising:
a first inverter module, a first resonant module, a first transformer module and a first rectifier module which are electrically connected in sequence; and a second inverter module, a second resonant module, a second transformer module and a second rectifier module which are electrically connected in sequence;
the first transformer module comprises a first primary winding and a first secondary winding;
the second transformer module comprises a second primary winding and a second secondary winding;
wherein input terminals of the first inverter module and the second inverter module are connected in parallel;
output terminals of the first rectifier module and the second rectifier module are connected in series to form a high voltage;
a phase of an output voltage of the first inverter module and a phase of an output voltage of the second inverter module are different.

2. The high-voltage generator according to claim 1, wherein the first transformer module further comprises a third primary winding, and the second transformer module further comprises a fourth primary winding;
wherein the third primary winding is connected in series with the first primary winding and coupled with the second secondary winding;
the fourth primary winding is connected in series with the second primary winding and coupled with the first secondary winding.

3. The high-voltage generator according to claim 2, wherein
the first transformer module comprises two oppositely arranged E-type magnetic cores to form a first EE-type magnetic core;
the second transformer module comprises two oppositely arranged E-type magnetic cores to form a second EE-type magnetic core;
the first primary winding is wound on a first magnetic pillar of the first EE-type magnetic core, and the third primary winding is wound on a first magnetic pillar of the second EE-type magnetic core;
the second primary winding is wound on a second magnetic pillar of the first EE-type magnetic core, and the fourth primary winding is wound on a second magnetic pillar of the second EE-type magnetic core;
the first secondary winding is wound around a first central pillar of the first EE-type magnetic core, and the second secondary winding is wound around a second central pillar of the second EE-type magnetic core.

4. The high-voltage generator according to claim 3, wherein the first magnetic pillar and the second magnetic pillar of the first EE-type magnetic core, the first magnetic pillar and the second magnetic pillar of the second EE-type magnetic core each have a first air gap, the first central pillar and the second central pillar each have a second air gap, a width of the second air gap is smaller than a width of the first air gap.

5. The high-voltage generator according to claim 1,
wherein the first resonant module comprises a first inductor and a first resonant capacitor connected in series;
the second resonant module comprises a second inductor and a second resonant capacitor connected in series;
an inductance difference between the first inductance and the second inductance is within a preset range.

6. The high-voltage generator according to claim 5, wherein the first primary winding and the second primary winding are respectively connected in parallel with a resonant capacitor.

7. The high-voltage generator according to claim 5, wherein the first inductor comprises a first UI-type magnetic core, and the second inductor comprises a second UI-type magnetic core; the first UI-type magnetic core and the second UI-type magnetic core share a same insulating component.

8. The high-voltage generator according to claim 5, wherein the first inductor and the second inductor share a third EE-type magnetic core, and the third EE-type magnetic core comprises two oppositely arranged E-type magnetic cores, wherein a winding of the first inductor is wound on a first magnetic pillar of the third EE-type magnetic core, and a winding of the second inductor is wound on a second magnetic pillar of the third EE-type magnetic core.

9. The high-voltage generator according to claim 8, wherein the first magnetic pillar and the second magnetic pillar of the third EE-type magnetic core each have a third air gap, and a central pillar of the third EE-type magnetic core has a fourth air gap, and a width of the fourth air gap is smaller than a width of the third air gap.

10. The high-voltage generator according to claim 5, wherein the first resonant module further comprises a third inductor, and the second resonant module further comprises a fourth inductor;
wherein the third inductor and the first inductor are connected in series, and the fourth inductor and the second inductor are connected in series.

11. The high-voltage generator according to claim 10, wherein the first inductor, the second inductor, the third inductor and the fourth inductor are all integrated in a fourth EE-type magnetic core, and the fourth EE-type magnetic core comprises a first E-type magnetic core and a second E-type magnetic core arranged oppositely;
wherein a winding of the first inductor is wound on a first magnetic pillar of the first E-type magnetic core, a winding of the second inductor is wound on a second magnetic pillar of the first E-type magnetic core, a winding of the third inductor is wound on a first magnetic pillar of the second E-type magnetic core, and a winding of the fourth inductor is wound on a second magnetic pillar of the second E-type magnetic core.

12. The high-voltage generator according to claim 11, wherein the first magnetic pillar of the first E-type magnetic core and the first magnetic pillar of the second E-type magnetic core each have a third air gap, the second magnetic pillar of the first E-type magnetic core and the second magnetic pillar of the second E-type magnetic core each have the third air gap, a central pillar of the first E-type magnetic core and a central pillar of the second E-type magnetic core each have a fourth air gap, and a width of the third air gap is greater than a width of the fourth air gap.

13. The high-voltage generator according to claim 1, wherein each of the first rectifier module and the second rectifier module comprises a plurality of sub-rectifier modules connected in series.

14. The high-voltage generator according to claim 2, wherein each of the first rectifier module and the second rectifier module comprises a plurality of sub-rectifier modules connected in series.

15. The high-voltage generator according to claim 3, wherein each of the first rectifier module and the second rectifier module comprises a plurality of sub-rectifier modules connected in series.

16. The high-voltage generator according to claim 4, wherein each of the first rectifier module and the second rectifier module comprises a plurality of sub-rectifier modules connected in series.

17. The high-voltage generator according to claim 5, wherein each of the first rectifier module and the second rectifier module comprises a plurality of sub-rectifier modules connected in series.

18. The high-voltage generator according to claim 6, wherein each of the first rectifier module and the second rectifier module comprises a plurality of sub-rectifier modules connected in series.

19. The high-voltage generator according to claim 7, wherein each of the first rectifier module and the second rectifier module comprises a plurality of sub-rectifier modules connected in series.

20. A high-voltage generator, comprising:
a three-phase inverter module, a resonant module, a transformer module and a rectifier module which are electrically connected in sequence;
the three-phase inverter module comprises three bridge arms and a capacitor connected in parallel;
the transformation module comprises three primary windings and three secondary windings, wherein the three primary windings are provided with a common connection point, and the three primary windings are respectively coupled with the three secondary windings;
each of midpoints of the three bridge arms is connected with the common connection point through a series connection of a resonant inductor, a resonant capacitor and one of the three primary windings;
the rectifier module comprises three rectifier units electrically connected with the three secondary windings respectively, and output terminals of the three rectifier units are connected in series; and
each phase of the three-phase inverter module has a different output voltage.
